(19) United States
(12) Patent Application Publication
(10) Pub. No.: US 2005/0049775 A1
(43) Pub. Date: Mar. 3, 2005

(54) Distributed engine control system and method

(75) Inventor: Thomas D. Mooney, Gloucester, MA (US)

Correspondence Address: Barbara Joan Haushalter;Law Office, 228 Bent Pines Court, Bellefontaine, OH, 43311, US

(73) Assignee: General Electric Company

(21) Appl. No.: 10/652,382

(22) Filed: Aug. 29, 2003

(51) Int. Cl. G06F 19/00

(52) U.S. Cl. 701/100; 477/30

(57) ABSTRACT

The present invention provides a system and method for safety critical real time distributed engine control. Centralized hierarchical control architecture is replaced with an autonomous distributed network. Analog input/output signals are replaced with digitized data packets. Point-to-point wiring and data bus control are replaced with flexible virtual connections using digital switching technology. Fixed redundancy is replaced with variable redundancy.

### BACKGROUND OF THE INVENTION

The present invention relates to distributed control systems and, more particularly, to an autonomous distributed network for engine control.

Hierarchical control systems have limited redundancy, lack flexibility, are subject to expensive obsolescence concerns, have extensive cabling requirements and have limited diagnostic capability. Transition from hard wired hierarchical systems to distributed systems has been ongoing within the voice, data, and video communication industry for several decades. These advancements have resulted in order of magnitude increases in bandwidth, major cost reductions and increased quality. While the technical concepts have been applied to some industrial control applications, current engine control systems still utilize hierarchical control architecture. System reliability is achieved by incorporating redundant control channels. Processing functions for each channel are controlled by the processors for that channel. Consequently, when the central processor unit for a channel fails, the functionality of that channel is lost.

A hierarchical control scheme leaves the entire system vulnerable to loss of all control channels. The loss of multiple processors can result in loss of engine control. While redundancy addresses many of the failure modes, it does not address all failure modes. Furthermore, a significant design burden affecting cost, weight and complexity, is encountered in the current architecture at redundancy levels greater than dual. As engines become more integrated into aircraft flight control systems, it becomes more critical to have the capability to select redundancy levels to achieve optimal system capability.

It would be desirable to replace the centralized hierarchical control architecture of current systems with an autonomous distributed network, to allow for flexible virtual connections and variable redundancy.

### BRIEF DESCRIPTION OF THE INVENTION

An architecture is proposed for allowing each control system element to locally and autonomously convert its analog information into digital data packets, or convert digital data packets into analog signals. While each sensor component still obtains measured data from its sensor elements, each sensor contains electronics to convert its data into digital data words.

Accordingly, the present invention provides a system and method for safety critical real time distributed engine control. Centralized hierarchical control architecture is replaced with an autonomous distributed network. Analog input/output signals are replaced with digitized data packets. Point-to-point wiring and data bus control are replaced with flexible virtual connections using digital switching technology. Fixed redundancy is replaced with variable redundancy.

Accordingly, the present invention provides an autonomous distributed network for meeting mission critical real time control needs of an aircraft gas turbine engine.

### BRIEF DESCRIPTION OF THE DRAWINGS

FIG. 1 is a schematic block diagram illustration of typical input components;

FIG. 2 is a schematic block diagram illustration of typical output components;

FIG. 3 is a schematic block diagram showing one possible configuration for a distributed control system; and

FIG. 4 is a block diagram illustration showing an autonomous digital control system for a gas turbine engine control system.

### DETAILED DESCRIPTION OF THE INVENTION

Modern gas turbine engine control systems typically consist of two fully capable, redundant, digital, electronic control system channels. Each control system channel has a full complement of sensors, signal processing electronics, control functions, and actuator drivers to assure safe, reliable engine operation throughout the aircraft flight envelope.

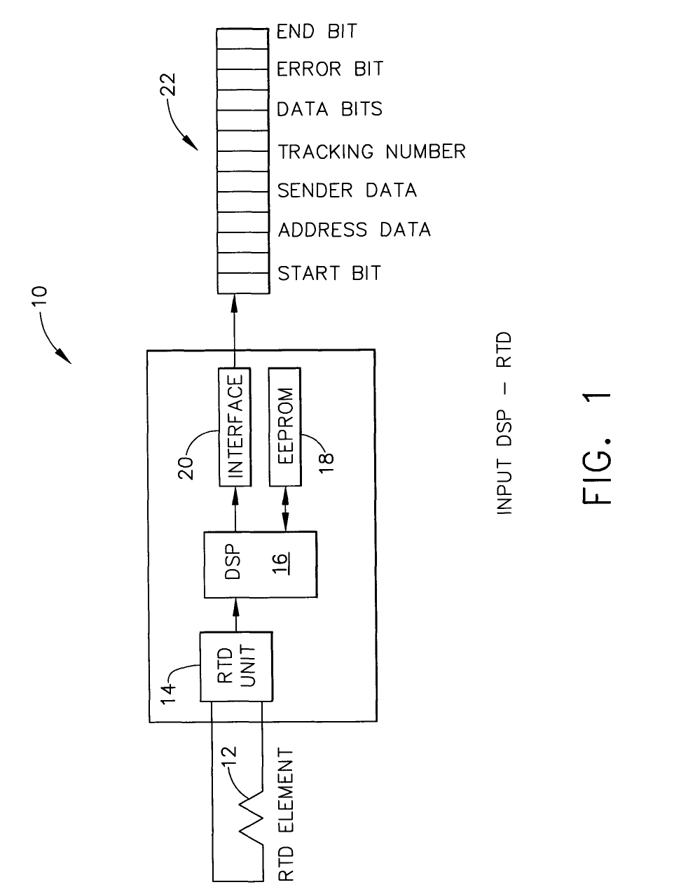

Current engine control systems incorporate analog input and output signals wired directly to the Full Authority Digital Engine Control (FADEC). FIG. 1 shows the configuration of a typical sensing unit 10 for the autonomous digital control system. Real time analog sensor data is acquired using a traditional sensing transducer, such as by measuring temperature via a resistive temperature device 12, applied to a sensing unit 14. The same principal would apply for any physical transducer. Electronics in the sensor would autonomously convert the analog signals into a stream of digital data words, as shown in FIG. 1. The digital data words conform to a standard data protocol for the digital signal processor (DSP, with information applied to the DSP block 16 from the RTD unit 14 and an EEPROM 18. The EEPROM would contain an address bit indicating the terminal destination for the data, a sender bit indicating the source of the data so that the receiver knows where the data originated, a tracking control number to indicate sequence and timing and to reassemble the data if it was split up for transfer, the data itself, error detecting information so the data can be error checked against bit corruption, and an end data bit, all indicated by reference number 22 of FIG. 1. Once the analog data is converted to a stream of digital data words, the data can be autonomously routed across the network, via the interface 20, to its destinations. Since the information is decoupled from its source transducer, all the data can be handled on the same network, components can be added or removed or upgraded, as desired by the system design team, and the path from the source to the destination is not dependent on any single connection.

Another important feature of the concept of the present invention is the separation of the transducer measuring element of the input from the data processing element. The transducer measuring components can be designed to meet the individual environmental needs for the particular engine, while the data processing components can be standardized across a wide number of engine platforms. This promotes interchangeability, easy upgrading to incorporate new technology, and rapid prototyping of new designs and design change concepts.

The unresolved problem with hierarchical control in existing systems is that loss of a channel's processor or bus controller results in total loss of the functionality of that channel. In a dual channel system, loss of function for one channel results in loss of all input and output from that channel. Consequently, data sharing between channels stops. Even when the input/output data is digitized outside the FADEC, the FADEC bus controller must poll the data. The data is unavailable for either channel when the bus controller fails. Although systems have been proposed which use busses classified as critical and non-critical, some signals still must remain hard-wired to meet reliability and safety requirements. Hence, state of the art systems have not overcome the inherent limitations imposed by hierarchical systems architecture.

Applying the architecture proposed by the present invention, each control system element would locally and autonomously convert its analog information into digital data packets, or convert digital data packets into analog signals. Since all signals are in the form of digital data, the connections between units can be any suitable connections, such as shielded twisted pair, coax, or fiber, replacing the current multi-conductor harnesses. The estimated reduction in the number of conductors to the processor units would be significant, reducing the need for cables, cable clamps, brackets and connectors. The autonomous distributed control system and method of the present invention comprises a plurality of control system elements. The control system elements can comprise input sensors, output components, processor and controlling components, switches, and recording components. Signal processing, computation, communication and recording functions, are autonomously carried out, wherein each of the plurality of control system elements can locally and autonomously convert its analog information into digital data packets or convert its digital data packets into analog signals. Digital switches autonomously route digital data packets across a network. The digital switches can route signals to destinations using, for example, twisted pair wiring capable of carrying multiple signals.

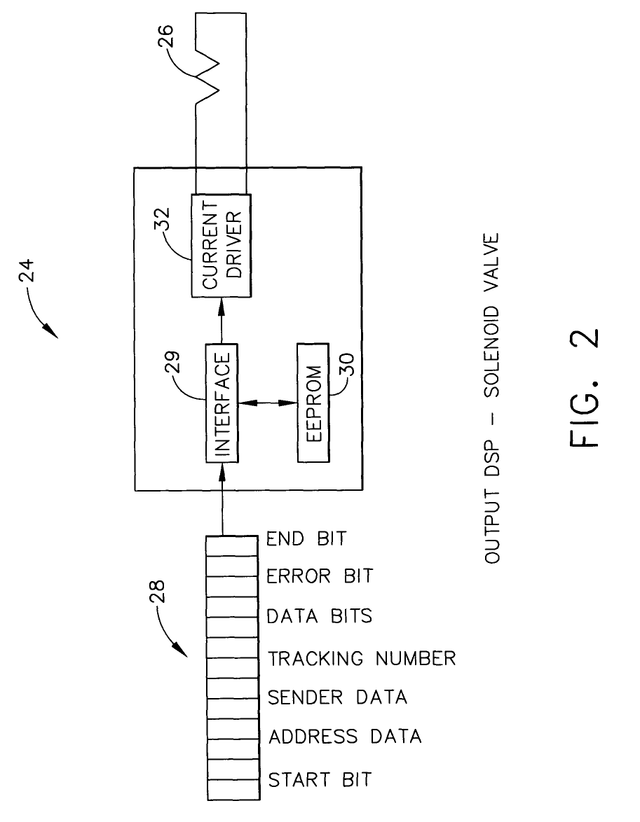

Each sensor component obtains measured data from its sensor elements. Referring now to FIG. 2, there is illustrated a typical output device 24 for an autonomous distributed control system. A properly coded digital word, such as received from data bits 28, would be autonomously read by the electronics in the output device 24, comprised of an interface 29, an EEPROM device 30, and a current driver 32. The data would then be converted into an analog output signal, where the analog output is the output of the current driver 32. This analog output could be used to operate any type of output device. In the example of FIG. 2, the analog signal is driving a solenoid valve 26. Hence, a properly coded data word can be autonomously routed to its designated address. Since the data is decoupled from the device generating it, using it, or processing it, the system has the benefits previously described. The decoupling allows as many or as few inputs, outputs or processing elements in the system as desired by the needs of the system designers. Digital switches can route signals to their destinations using twisted pair wiring which can carry multiple signals and can autonomously route signals around breaks, if necessary. The digital switches can autonomously reroute signals.

In accordance with the present invention, each sensor contains the electronics necessary to convert its data into digital data words. Digital signal processors (DSPs) can be used to convert data for standard engine sensors. This approach decouples the data used by the control system from the particular hardware element. Basic input signal management can be done at the sensor, and error-coding information can be embodied in the data word.

Continuing with FIGS. 1 and 2, using a standard protocol commonly known and used in commercial systems, the data can be converted into fixed size message blocks at the sensor and sent over the engine network to the address or addresses intended for the data. Each message block includes at least a start bit, an address bit, a sender identification bit, bit locations for tracking identification, the data itself, an error detection bit, and an end message bit, as illustrated in FIGS. 1 and 2.

The input data packet is autonomously transmitted onto the engine digital network. Digital switching nodes in the network would autonomously route the message across the network, directing the message to its terminal address. Embedded algorithms at each node insure that the data is sent to the correct address via the optimum route, creating a virtual connection between sender and recipient. High speed digital switching creates virtual signal paths between nodes. Digital switches can establish optimum connection paths between addresses and can reroute signals to adjust to conditions such as disabled signal paths. Hence, in a preferred embodiment, the routers are programmed to reroute data packets around failed lines. Failed lines are detectable by the lack of a confirming response that the signal has been received at the next node. This assures reliable connections, even under adverse conditions.

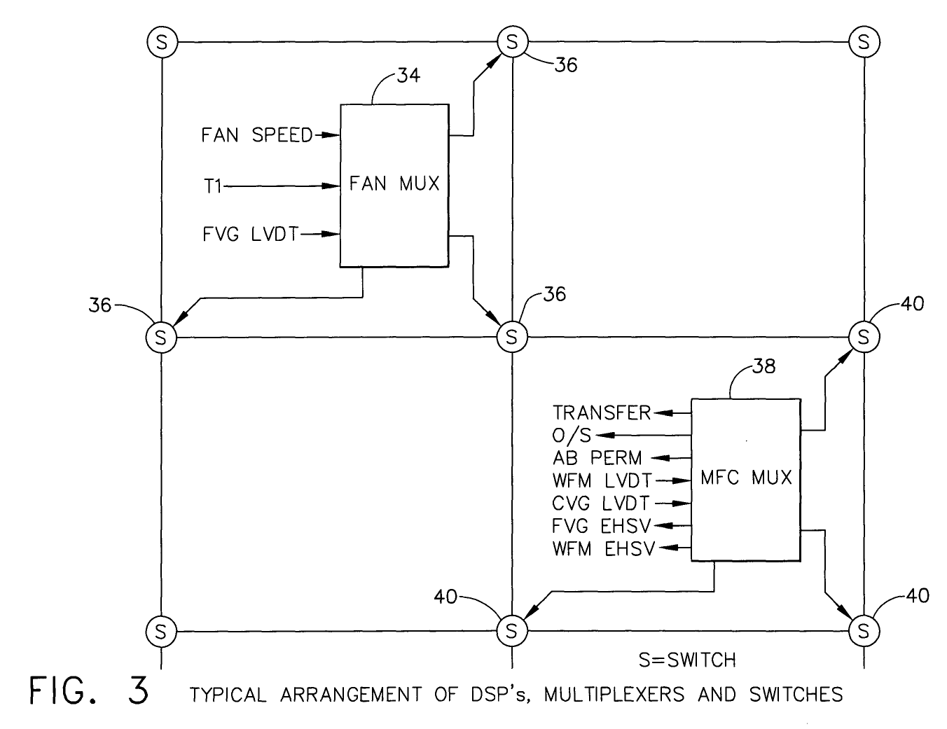

Once the data arrives at its destination, the recipient component opens the message and uses the data contents as programmed. The tracking bit in the message can be used to monitor data latency and avoid loops. FIG. 3 shows a typical arrangement of components in a section of an autonomous digital control system. In accordance with one embodiment of the present invention, digital data packets containing information on fan speed, fan inlet temperature (T1), and Fan Variable Geometry (FVG) position as measured by a linear variable differential transformer (LVDT), are multiplexed in a multiplexer (fan mux) at block 34 then sent to the three adjacent digital switches 36 for transmission over the network to their destinations. The destination address is part of the digital word being sent. Since each digital switch reads the destination, and switch knows autonomously where it is, it knows via a lookup table the preferred routes to send each signal so that it will reach its destination. If a signal fails to make it to the switch to which it is sent, as indicated by no return receipt message from the switch, the switch will conclude that the path to that switch is down and will retransmit the signal to some other switch. Since each switch is connected to several others, the system can continue to operate with multiple line outages.

Continuing with FIG. 3, there is also illustrated a multiplex unit 38 at the main fuel control Unit 38 is shown sending and receiving data from three other switches 40 on the network. In the example shown, the signals are driving outputs including a transfer valve solenoid (Transfer), overspeed solenoid (O/S), afterburner permission solenoid (AB Perm), fan variable guide vane (FVG) electro hydraulic servo valve (EHSV) current and main fuel metering valve position current (WFM), as well as receiving signals from WFM (fuel metering valve) and CVG (compressor variable geometry) position as measured by a linear variable differential transformer (LVDT).

Actuators, shown in FIG. 3 as the transfer valve solenoid, the overspeed solenoid, the AB permission solenoid, the FVG EHSV and the WFM EHSV, respond to the digital data packets addressed to them. An output DSP, embedded in the transducers and actuators as shown in FIGS. 1 and 2, generates the analog output as directed by the valid data in the data packet. Although the prior art would have the main processors be the addressees for most of the sensor data, in accordance with the present invention the processors are not performing the input/output signal processing or controlling the network. The functions of the individual components are autonomous, including receiving data, calculating the control dynamics, and sending digital data packets to the rest of the network. Output messages from the processors would be addressed to the desired actuators over the same network.

Since the system of the present invention allows for multiple processor control, tasks could be divided up based on design preference. Processors could be dedicated to multifunction control, or to specific functions such as anti-ice or control of an anti-ice valve system, overspeed protection, stall margin protection, or a combination thereof. Additionally, some processors can run high order models, since all of the data could be made available, and be used in a voting scheme to resolve anomalies.

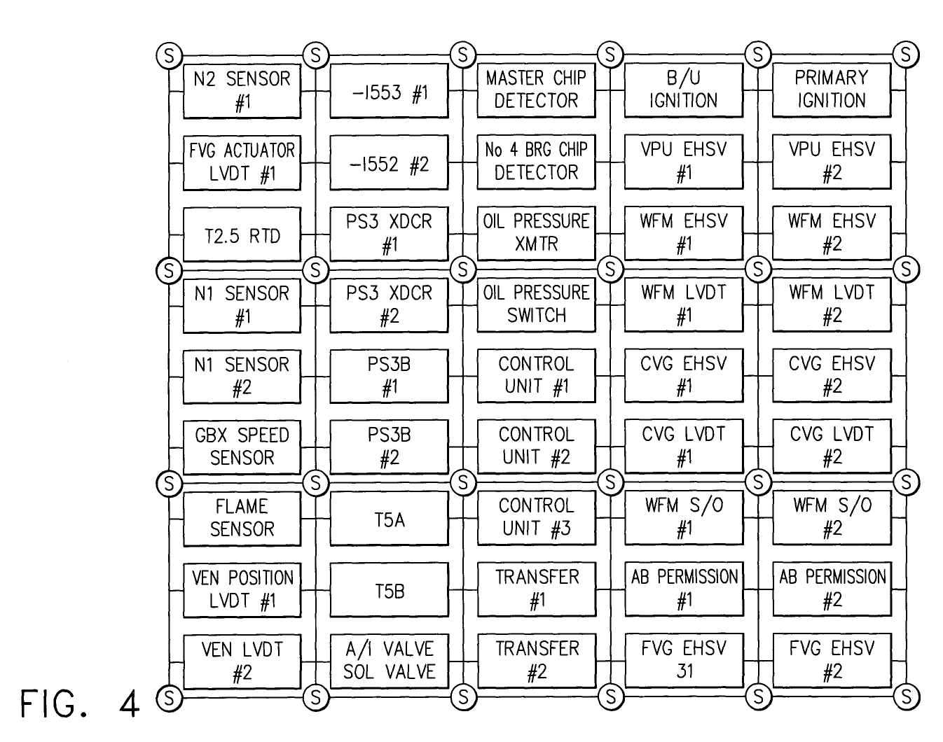

An example of a full engine control system, configured using the autonomous digital control system concept in accordance with the present invention, is illustrated in FIG. 4. Within each block shown in FIG. 4, digital signals are generated, processed or used. The Control Units in FIG. 4 may be computers which receive data from multiple sources including other control units, process the data as is currently done by the FADEC in traditional systems, and send digital data words out to other components of the system. As long as the control units maintain the interface protocol, they can be added, subtracted, or upgraded without impacting the rest of the system. The ability to allow easy infusion of new control technology is a major advantage of the system of the present invention.

Continuing with FIG. 4, each of the components shown is connected to the web and has multiple signal paths through various digital switches S. The digital switches read the address in the data message and autonomously sent the data toward its address. At the terminal address, the signals are assembled, interpreted, used or processed. Error detection in the switches can route signals around failed paths and error detection within the digital word can find and correct bit corruption errors within the data. The autonomous distributed network of the present invention meets the critical real time control needs of an aircraft gas turbine engine.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An autonomous distributed control system for a gas turbine engine, comprising:
a plurality of control system elements;
means for autonomously carrying out signal processing, computation, communication and recording functions, wherein each of the plurality of control system elements can locally and autonomously convert its analog information into digital data packets or convert its digital data packets into analog signals; and
a plurality of digital switches to autonomously route digital data packets across a network.

2. A system as claimed in claim 1 further comprising an interface for autonomously routing data across the network.

3. A system as claimed in claim 1 wherein all signals are in digital data form.

4. A system as claimed in claim 3 wherein connections can comprise non-multi-conductor harnesses.

5. A system as claimed in claim 3 wherein the digital data packets are decoupled from any device operating said digital data packets.

6. A system as claimed in claim 1 further comprising flexible virtual connections using digital switching technology.

7. A system as claimed in claim 1 wherein the data is decoupled from its source transducer to allow all the data to be handled on a single network.

8. A system as claimed in claim 1 wherein transducer measuring components are designed to meet individual environmental needs.

9. A system as claimed in claim 1 wherein data processing components are standardized across engine platforms.

10. A system as claimed in claim 1 wherein the plurality of digital switches routes signals to destinations using twisted pair wiring capable of carrying multiple signals.

11. A system as claimed in claim 10 wherein the plurality of digital switches are capable of autonomously rerouting signals.

12. A method for critical real time distributed engine control for a gas turbine engine, comprising the steps of:
providing a plurality of control system elements;
autonomously carrying out signal processing, computation, communication and recording functions, wherein each of the plurality of control system elements can locally and autonomously convert its analog information into digital data packets or convert its digital data packets into analog signals; and
providing a plurality of digital switches to autonomously route digital data packets across a network.

13. A method as claimed in claim 12 further comprising the step of providing an interface for autonomously routing data across the network.

14. A method as claimed in claim 12 wherein all signals are in digital data form.

15. A method as claimed in claim 12 further comprising the step of using flexible virtual connections using digital switching technology.

16. A method as claimed in claim 12 wherein the data is decoupled from its source transducer to allow all the data to be handled on a single network.

17. A method as claimed in claim 12 wherein transducer measuring components are designed to meet individual environmental needs.

18. A method as claimed in claim 12 wherein data processing components are standardized across engine platforms.

19. A method as claimed in claim 12 wherein the plurality of digital switches routes signals to destinations using twisted pair wiring capable of carrying multiple signals.

20. A method as claimed in claim 19 wherein the plurality of digital switches are capable of autonomously rerouting signals.
